(19) United States
(12) Patent Application Publication
(10) Pub. No.: US 2026/0295965 A1
(43) Pub. Date: Oct. 1, 2026

(54) METHOD AND SYSTEM FOR MANUFACTURING PRESSED BOARD TRAYS

(71) Applicant: CONFOIL PTY LTD, Bayswater, Victoria (AU)

(72) Inventors: Wayne Edwin ROGERS, Montrose, Victoria (AU); Andrew James HENDERSON, Lilydale, Victoria (AU)

(73) Assignee: CONFOIL PTY LTD, Bayswater, Victoria (AU)

(21) Appl. No.: 19/478,583

(22) PCT Filed: Apr. 23, 2024
(86) PCT No.: PCT/AU2024/050385

§ 371 Date: Oct. 24, 2025

(30) Foreign Application Priority Data
Apr. 28, 2023 (AU) 2023901249

(51) Int. Cl. B31B 50/25; B31B 50/04; B31B 50/14; B31B 50/16; B31D 5/02

(52) U.S. Cl. CPC B31B 50/256; B31B 50/044; B31B 50/146; B31B 50/16; B31D 5/02; B31B 2241/00

(57) ABSTRACT

In this method/machine to manufacture pressed board trays the scoring and cutting operations are separated. A continuous web of paperboard from roll is fed through an Infeed Table, a pair of Decurl Rollers and into the first Web Drive Nip Roller. The Infeed Table provides an initial guided edge to help centre the web through the machine. The Decurl Rollers, are adjustable. The web then passes through a scoring cassette containing a pair of scoring rollers before being passed to a cutting cassette containing a pair of cutting rollers (one of which is a magnetic roller to hold and allow easy replacement of a cutting knife) to create separate shaping blanks which are then fed to a separate forming press. The shaping blanks are pressed to produce a finished pressed board tray having a recess surrounded by a flange.

### FIELD OF THE INVENTION

The present invention relates to the field of manufacturing pressed board trays, specifically to a method and system for improving the manufacturing process and for machines designed to implement this new method.

### BACKGROUND OF THE INVENTION

Conventionally, pressed board container manufacturing has been challenging due to the difficulty in achieving two outcomes in a single function. Existing flatbed die cutters often require both the cutting and scoring of a blank to be performed simultaneously, leading to issues in maintaining a full depth score and achieving a good cut.

### Prior Art Die Cutters

a) With existing flatbed die cutters (traditionally used in pressed board container manufacture) you have to both cut the outside profile & score the corner creases in the same action.

b) It is difficult to achieve/maintain a full depth score & cut the blank in the same motion.

c) Cutting the blank is a must happen function so, often the scoring is compromised.

d) To achieve an effective cutting of the blank often the press is over-stroked which in turn damages both the blades & cutting plate shortening their serviceable life.

### Hydraulic Male Form

a) In the forming process the die must both bottom out on the male form/female form to achieve a well-defined tray and at the same time the draw ring/female form to achieve a flat flange.

b) There are typically 3 or more cavities in a production die so a minimum of 6 areas of contact and as such presents a difficult task to the operator.

c) A flat flange is the more critical (and easier) to achieve over 3 cavities, so often the container shape is compromised in achieving the flat flange.

d) Also, if a “jam up” occurs in the die the alignment of the male-female form can be pushed out necessitating production to be stopped and the die to be realigned.

In the forming process, a die must bottom out on the male form/female form to achieve a well-defined tray, while the draw ring/female form is pressed to achieve a flat flange. Such a process presents a difficult task to the operator and often compromises the container shape in achieving the flat flange.

With the prior art score and cut system, shim sheets have been established where shims are stuck to a sheet of paper and placed under the counter plate. These sheets are different for each press and have to be stored. Often the stored shims fall off.

If a knife is over stroked, it will both take the edge off the knife and repeated occurrences will damage the counter plate. Additionally changing the knife repeatedly compromises the integrity of the cutting plate leading to a shorter production life.

The prior art system is unsatisfactory and leads to poor quality products and/or risk to the operator.

### OBJECT OF THE INVENTION

To improve on the manufacture of pressed board trays or at least to provide the public with a useful choice.

### SUMMARY OF THE INVENTION

The present invention provides a method and system for improving the manufacturing process of pressed board trays, e.g., from paperboard or fibreboard supplied as a continuous web from a roll.

The primary inventive concept involves separating the scoring and cutting of a blank and forming of a container and flattening of the flange, as set out in the claims annexed hereto.

In one aspect the invention provides a method of manufacturing pressed board trays in which a continuous web of paperboard or fibreboard is passed through separate pair of scoring rollers before being passed to a separate pair of cutting rollers to create shaping blanks which are then fed to a separate forming press.

Preferably the web is passed through a Decurl cassette before entering the scoring rollers.

In another aspect the invention provides a machine for manufacturing pressed board trays having a source of a continuous web of paperboard or fibreboard and means for feeding the web into the machine having a scoring cassette separated from a cutting cassette, and a separate forming press.

Preferably the machine also includes a Decurl cassette between the source of the web and the scoring cassette so that the web can be flattened/uncurled before entering the scoring cassette.

Preferably the source of the web is provided by an unwinder having a roll drive wheel capable of supporting a roll of paperboard or fibreboard and a guided pneumatic cylinder to raise and lower the roll drive wheel.

Preferably the roll drive wheel is driven by an electrical gearmotor acting on a large cast aluminium wheel bung.

Preferably there is a sensor (more preferably an ultrasonic sensor) which generates a signal to automatically control the amount of web being unwound in use.

Preferably the scoring cassette has a pair of rollers to score the web.

Preferably the cutting cassette has a pair of rollers to cut the web.

Preferably the cutting cassette has a magnetic cylinder and an anvil cylinder, the magnetic cylinder supporting a magnetic knife so that the cutting pattern can be easily changed by removing the magnetic knife and inserting a different magnetic knife.

Preferably the forming press has a male form which can be moved hydraulically towards and away from the female form to allow the blank to be formed separately from pressing a flange around the tray.

In a further aspect the invention provides a machine for manufacturing pressed board trays having a source of a continuous web of paperboard or fibreboard comprising a roll drive wheel capable of supporting a roll of paperboard or fibreboard and a guided pneumatic cylinder to raise and lower the roll drive wheel capable (in use) of feeding the paperboard or fireboard towards processing stations.

Preferably the roll drive wheel is driven by an electrical gearmotor acting on a large cast aluminium wheel bung.

Preferably there is a sensor (more preferably an ultrasonic sensor) which generates a signal to automatically control the amount of web being unwound when in use.

Preferably the machine also includes a Decurl cassette between the source of the web and the processing stations so that the web can be flattened/uncurled before being processed.

Preferably the source of the web is provided by an unwinder having a roll drive wheel capable of supporting a roll of paperboard or fibreboard and a guided pneumatic cylinder to raise and lower the roll drive wheel.

Preferably the roll drive wheel is driven by an electrical gearmotor acting on a large cast aluminium wheel bung.

Preferably there is a sensor (more preferably an ultrasonic sensor) which generates a signal to automatically control the amount of web being unwound in use.

### DRAWINGS

FIG. 1. shows an overview of the right-hand configuration of the machine.

FIG. 2. shows the unwinder and roll stand in isolation.

FIG. 3. shows the top of the roll unwind and roll stand (in the empty state).

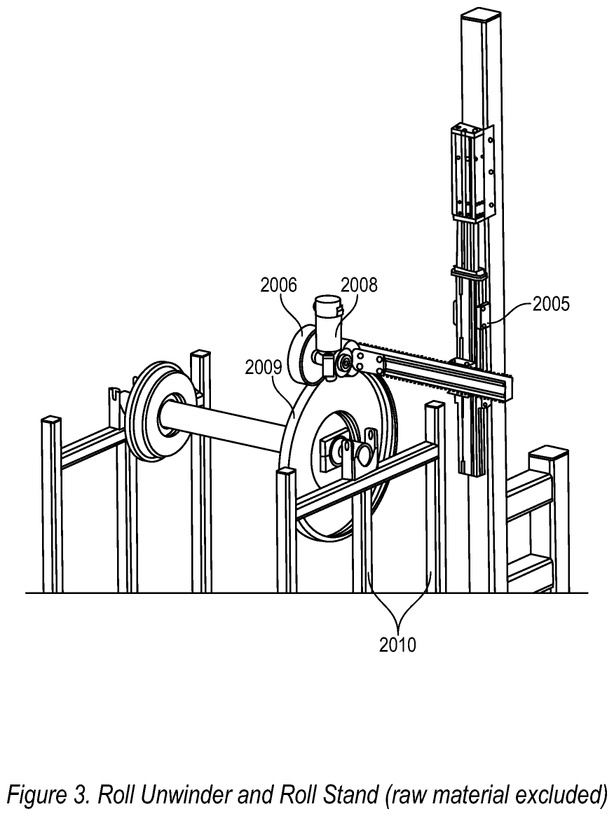

FIG. 4. shows the Web Decurl Cassette isolated from the rest of the machine.

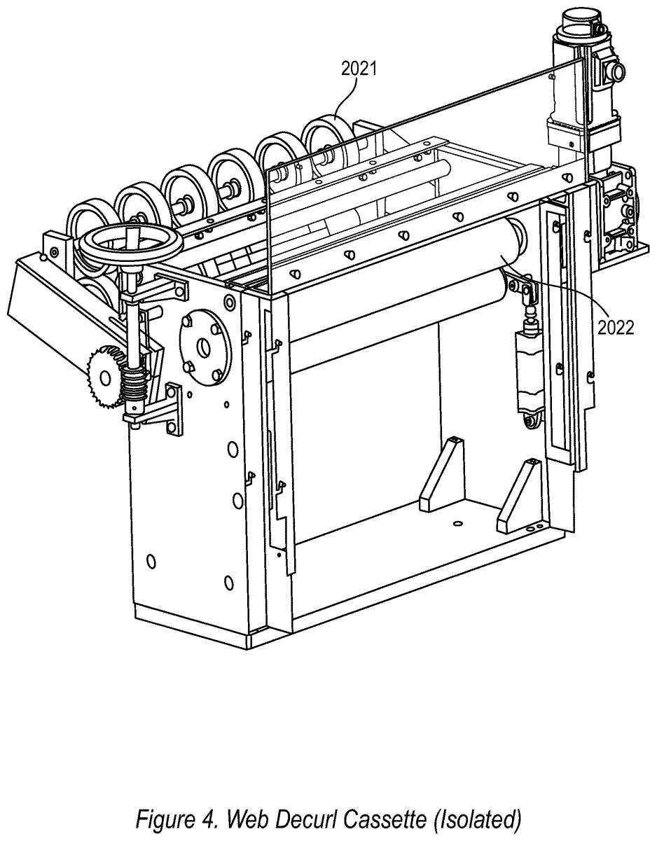

FIG. 5. shows the shows the Web Decurl Cassette in position fed from the roll unwinder.

FIG. 6. shows the Scoring Cassette in isolation.

FIG. 7. shows the Scoring Unit (with the base and module separated to illustrate their parts).

FIG. 8. shows the Scoring Cylinder with the bearing blocks exposed.

FIG. 9. shows the Cutting Cassette in isolation, viewed from the infeed face.

FIG. 10. shows the Cutting Cassette in isolation, showing the outfeed face.

FIG. 11. shows the Score and Cut Outfeed Chutes.

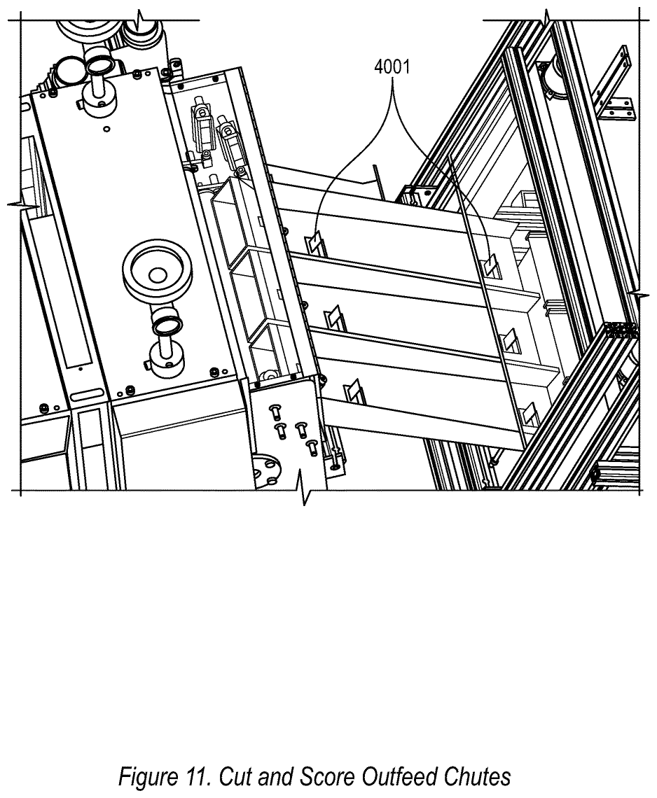

FIG. 12. shows the Forming Press in isolation, without tooling.

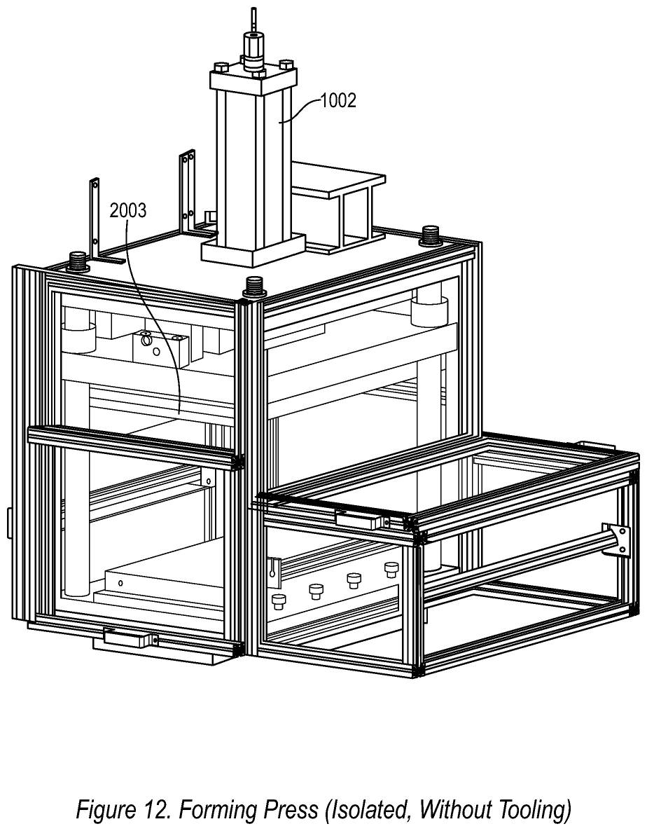

FIG. 13. shows the hydraulic male form in the UP position.

FIG. 14. shows the hydraulic male form in the DOWN position.

FIG. 15A. shows a cut blank with score marks before pressing.

FIG. 15B. Shows the tray pressed from the blank of FIG. 15.

FIG. 15C. Shows a top plan view of the pressed tray.

### DETAILED DESCRIPTION OF THE INVENTION

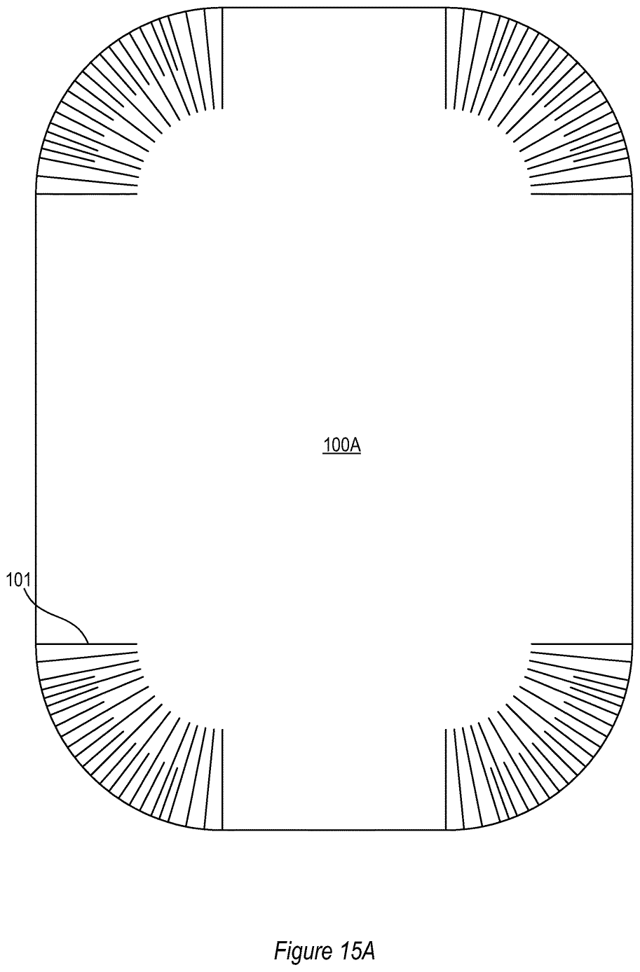

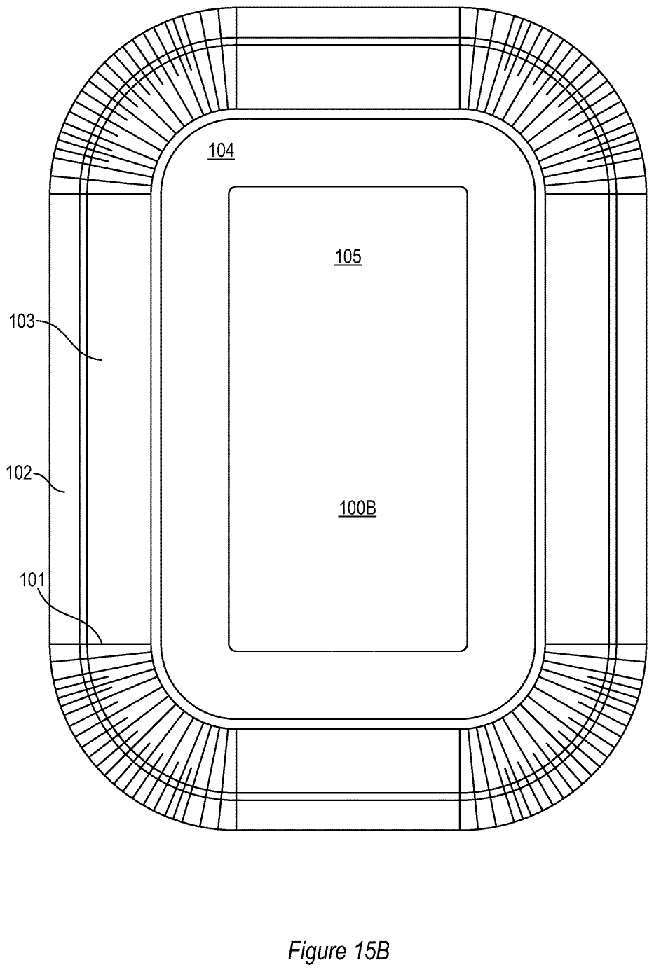

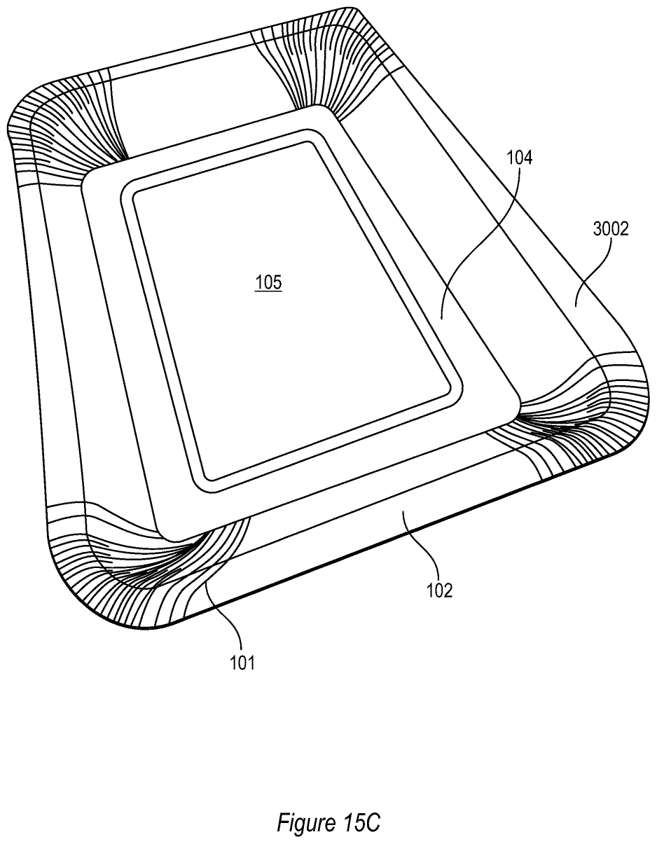

An example of a typical blank 100A in accordance with this invention, which has been scored and then cut prior to pressing is shown in FIG. 15A. This blank 100A is generally rectangular in nature with rounded corners, with scorelines 101 extending substantially radially inwards at each corner.

FIG. 15B is a top plan view of the tray 100B be after it has been pressed showing that the scorelines 101 help to create slight folds at each corner and extend from the newly formed flange 102 down the side wall 103 but stop short of the base portion 104. Optionally the base portion 104 may have a slightly raised central portion 15. These scorelines and resulting folds are shown in the perspective view of FIG. 15C.

In our preferred score and cut system, a rotary system has been used for both separate functions, and an inward and outward web nip controls the position of the board in the score and cut system at all times until the tray is cut from the web. However, when the tooling (score and cut) are disengaged (web dead zones), the web is driven by the inward and outward nip rollers. While they disengaged, we can adjust the print registration.

The score has been designed where the depth of the score is fixed by load bearers on the cylinders, ensuring a uniformly scored blank is delivered every time.

The scoring system has been mounted in a cassette for easy changeover.

The cutting system preferably uses a magnetic cylinder and a flexible knife with the cutting height set via bearers on both rollers, which can be changed for different profiles.

The preferred score and cut system will automatically adjust for production variations in print length. In the forming process, the male form has been placed on a hydraulic cylinder where the pressure and timing can be controlled.

Preferably the male form is extended 3 mm above its normal home position, so in the forming process, it will always have full contact with the female form.

Preferably at the bottom of the stroke, the pressure is turned off the hydraulic cylinder, and the male form can fall 1 mm below its home position, so all the pressing force is transferred to the flange.

Preferably the male form has 1 mm lateral movement for self-aligning should the die have a “jam-up.”

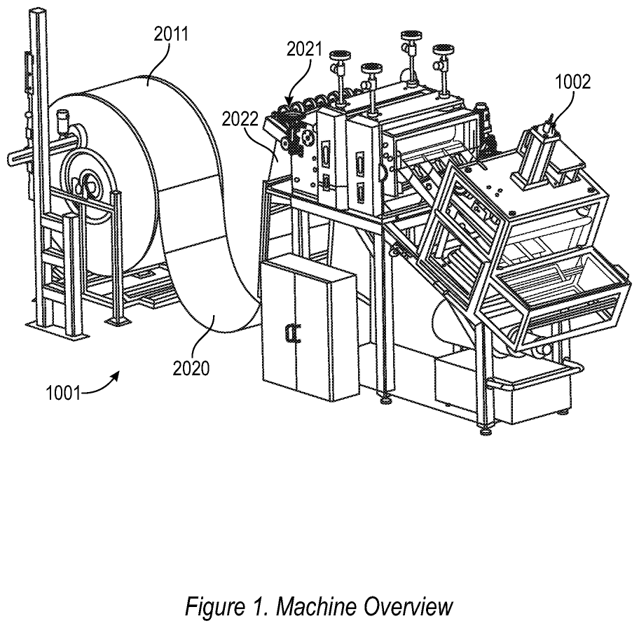

The drawings show the machine components and also the preferred sequence of operation in FIG. 1, which is the right-hand configuration of the machine. Left and right configurations exist in order to share a working platform (not shown) which allows access to the higher controls. The overall machine 1001 is shown in FIG. 1.

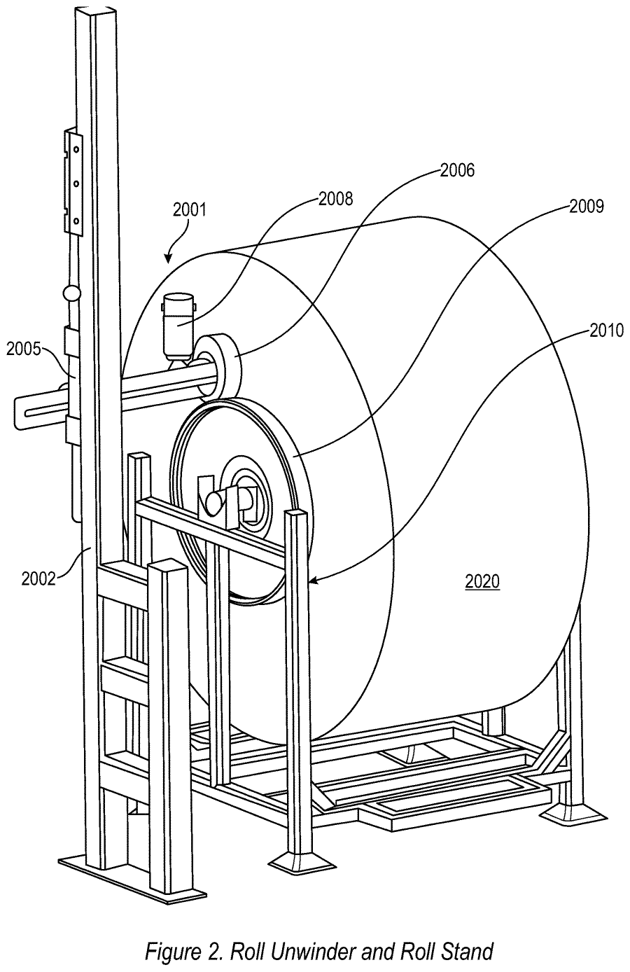

FIG. 2. shows the unwinder 2001 and roll stand 2002 in isolation. The unwinder features a guided pneumatic cylinder 2005 to raise and lower the roll drive wheel 2006. Air is supplied from the main airbox (not shown) located under the press platform. The roll/web is driven by an electrical gearmotor 2008 acting on a large cast aluminium wheel bung 2009. Feedback from an ultrasonic sensor (not shown) controls the amount of web unwound. Aluminium T-Slot profile and custom sliders (generally designated by 2010) allows the X-Y movement required to compensate for roll alignment. Horizontal movement is locked by means of a standard toggle clamp (not shown).

The web 2020 (see also FIG. 1) is fed through the Infeed Table, Decurl Rollers 2021 and into the first Web Drive Nip Roller 2022. The Infeed Table 2023 provides an initial guided edge to help centre the web through the machine. The Decurl Rollers 2021, which are adjusted through a worm gear setup 2024 on a common shaft, provide a straightening effect on the web to compensate for the natural curve when rolling the raw material.

Toolless web drive occurs through the servo operated nip rolls 2022, 2025 at the Web Decurl and Cutting Cassettes 2030. The Infeed Nip Roller 2022 is engaged by means of a manual valve close to the feed area, this allows the operator to clamp the web during the setup.

The ‘home’ positions for the Scoring 2026 and Cutting cylinders 2030 are saved in the machine's program, which, when combined with other fixed parameters of the machine (cylinder circumference, centre distances, and engage points), provide alignment between the cutting and scoring profiles. Feedback from the registration sensor (photoelectric) allows the web to be lined up with the score and cut units to provide a repeatable blank cutting process. Both the Scoring 2026 and Cutting Cassettes 2030 are tool interchangeable.

The Scoring Cassette 2030 features a removable module 2026 which contains the matched pair of male/female scoring cylinders for each product. Scoring pressure is achieved by means of the adjustable hydraulic jacks 2028 (we use “Hydrajacks” a trademark of Rotometrics) which apply pressure onto the Pressure Plate 2029 which houses cam followers that apply direct pressure onto the cylinder bearers.

Preferably there is a fixed, non-interference, clearance between the male and female scoring cylinders which provides fixed, maximum score depth by means of a bearer of the scoring cylinder.

Preferably the use of zero-backlash split gears 2033 between the driven cylinder and the scoring cylinders ensures perfect alignment. Cylinders are loaded into the module via bearing blocks which slide into the matched slots on either side of the frame.

The Cutting Cassette remains as a complete unit and features a magnetic cylinder 2034 with flexible cutting knives 2035 for each product. Similar to the Scoring Cassette, cutting pressure is achieved through the force transfer down from the Hydrajacks onto the cylinder bearers 2032.

Cutting of the blanks 100A occurs due to the zero-clearance interaction between the cutting knife and the anvil cylinder which is held at a fixed cut height by load bearers 2032 on the magnetic cylinder 2034. Variation in the cutting pressure simply limits the amount of separation between the magnetic (knife) and anvil cylinders. The magnetic cutting knife is aligned through matched, removable dowels 2036. The knives 2035 are rolled onto and off the magnetic cylinder 2034 when a tool change is required.

Blanks 100A shown in FIG. 15A are metered into the Forming Press using sequence controlled blank stops. Timed release of the blanks stops is essential to machine flow as the correction cycle of the score and cut sequence takes longer than a typical cycle. This buffer allows the forming press to operate at fixed time cycles.

The forming press uses a proportionally controlled single hydraulic ram 1002 inside a typical platen press configuration. Heating elements and insulating plates 2003 are installed on the moving platen to provide heat for the upper (female) die.

Provisions exist for heating on the lower, fixed base if required.

Tooling is changed by means of a portable, height and angle adjustable, trolley. The machine is controlled by a single PLC with a main HMI (not shown) located at ground level and an auxiliary HMI (not shown) on the access platform to assist in machine setup. A centralised airbox houses (not shown) the air regulators and solenoids required for the machine's functions. A smaller, satellite, airbox (not shown) has been installed at the front of the forming press for the unique product stackers.

The present invention provides a system for manufacturing pressed board trays of the type shown in FIG. 15C, comprising two separate functions: score and cut, and forming.

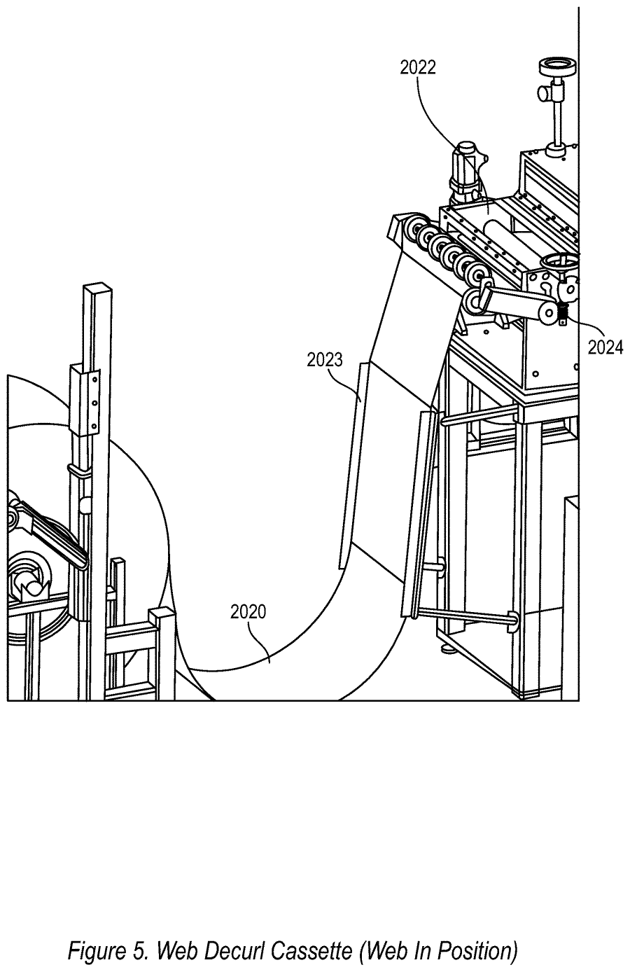

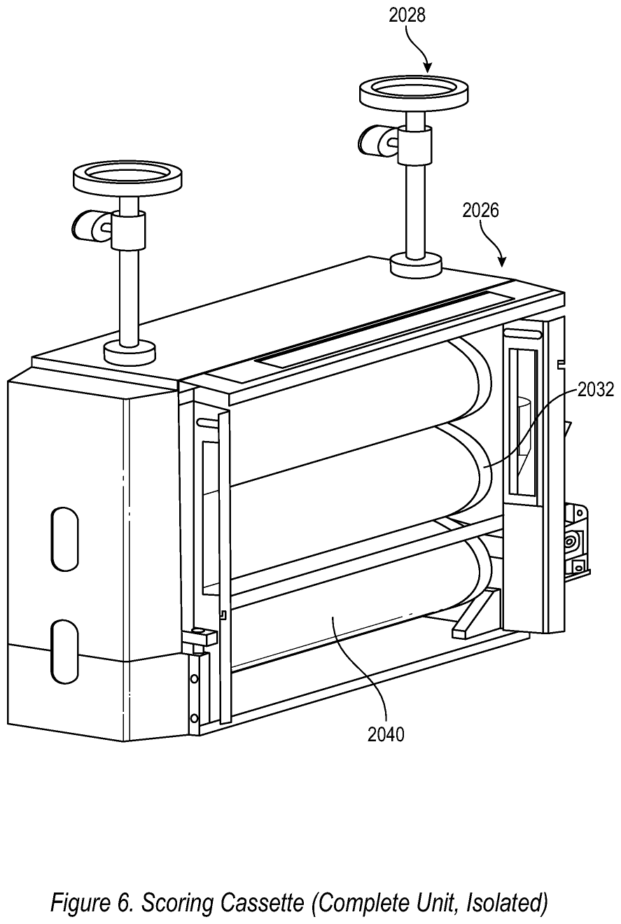

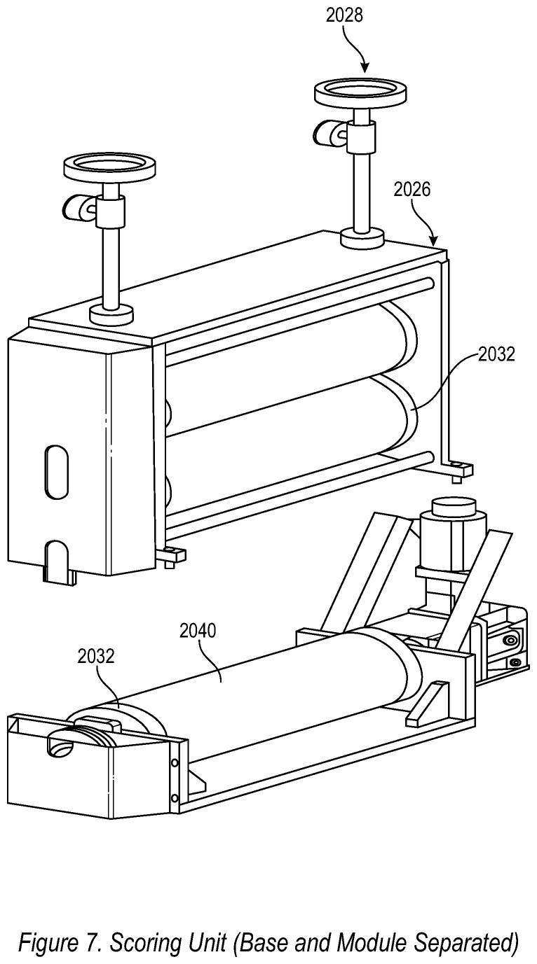

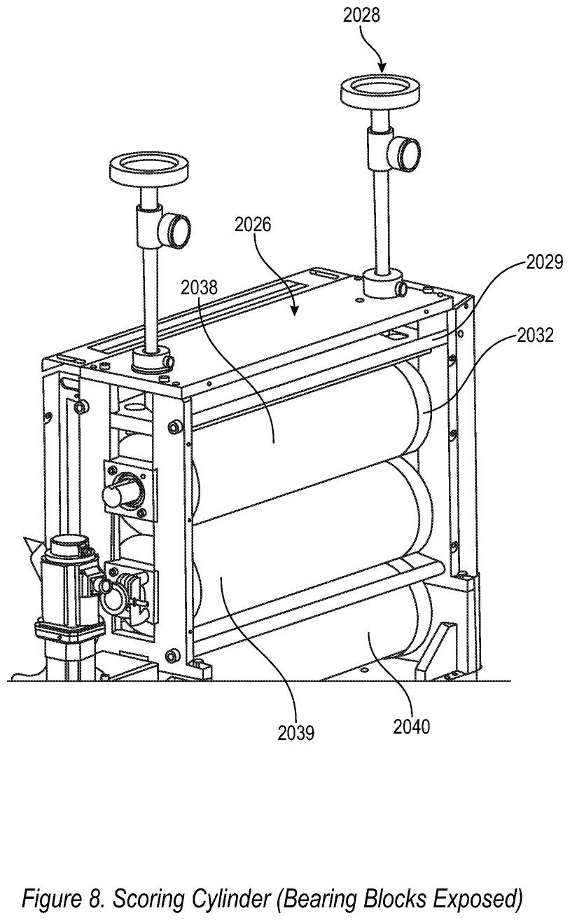

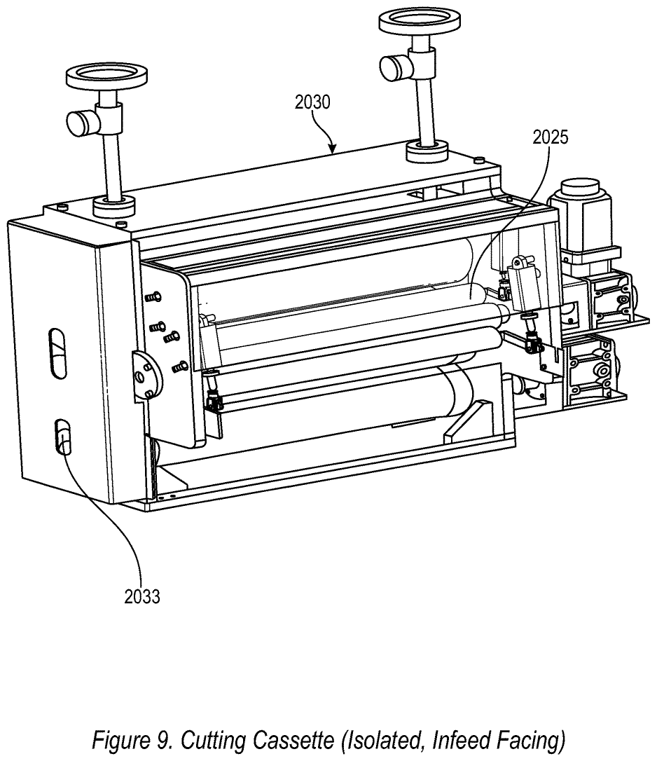

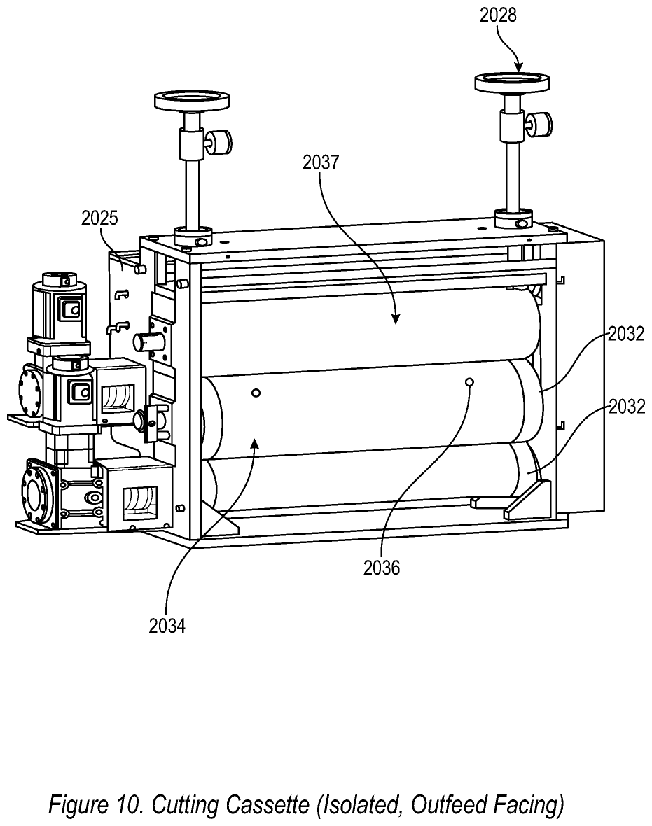

The score function shown in FIGS. 6 to 8 and the separate cut function shown in FIGS. 9 and 10, both use a rotary system for each function, with inward nip rollers 2023 (FIG. 5) and outward nip rollers 2025 (FIG. 9) controlling the position of the board at all times.

The score has a fixed depth maintained by load bearers 2032 on the cylinders.

The scoring system is mounted in a cassette 2027 for easy changeover, and the cutting system uses a magnetic cylinder 2034 and a flexible knife 2035 with the cutting height set via bearers on both rollers. The cutting knife is changeable for different profiles, and the score and cut system will automatically adjust for production variations in print length.

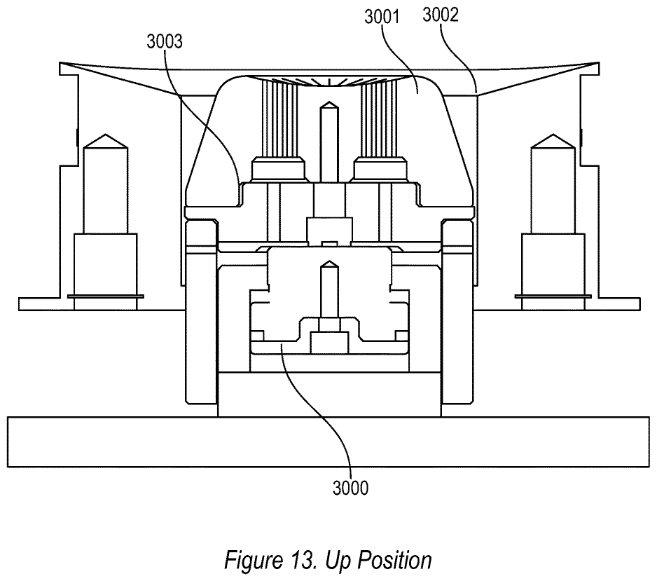

The forming function uses a hydraulic cylinder FIG. 13/3000 to control the pressure and timing of the male form 3001. The male form is extended 3 mm above its normal home position to ensure full contact in the female form during the forming process.

At the bottom of the stroke, the pressure is turned off, and the male form 3001 can fall 1 mm below its home position, allowing all the pressing force to be transferred to the flange 3002. The male form also has 1 mm lateral movement 3003 for self-aligning should the die have a “jam-up.”

### Rotary Score & Cut

a) The blank scoring & cutting functions have been separated into individual operations.

b) A rotary system has been used for both functions.

c) An inward 2022 & outward 2025 web nip controls the position of the board in the score & cut system at all times.

d) The score has been designed where the depth of the score is fixed by load bearers 2032 on the cylinders 2034, 2037, 2038, 2039, 2040. This ensures a uniformly scored blank is delivered every time.

e) The scoring system has been mounted in a cassette 2027 for easy change over.

f) The cutting system uses a magnetic cylinder 2034 and a flexible knife 2035 with the cutting height set via bearers 2032 on both rollers but can be set on one cylinder only.

g) The flexible knife is changeable for the differing cut profiles required.

h) The score & cut system will automatically adjust for production variations in print length

### Hydraulic Male Form.

i) The male form 3001 has been placed on a hydraulic cylinder 3000 where the pressure & timing can be controlled.

j) The male form 3001 is extended 3 mm above its normal home position so in the forming process will always have full contact in the female form.

k) At the bottom of the stroke the pressure is turned off the hydraulic cylinder and the male form can fall 1 mm below its home position, so all the pressing force id transferred to the flange 3002.

l) The male form has 1 mm lateral movement 3003 for self-aligning should the die have a “jam up”.

Scoring is achieved with matched male & female rollers 2038, 2039 that have a set gap (via bearers on the rollers) that maintain a set scoring profile which needs no adjustment in setting up. Cutting is achieved with an anvil roller 2037 & a magnetic roller 2034 again with bearers 2032 to maintain a set gap to facilitate a set cut height. A flexible knife adheres to the magnetic cylinder which is changeable for the different profiles.

Container shape is established and maintained with a male form 3001 on a hydraulic cylinder 3000 that fully formed prior to the bottom of the stroke where it switches off the hydraulic pressure & the total force of the press is transferred to the flange 3002.

### Score and Cut

The bearers on the scoring rollers 2032 maintain a fixed gap to a consistent score depth is achieved even when a scoring cassette 2026 is removed and then reset in a subsequent production run without the operator having to adjust the settings.

The bearers 2032 on the cutting cassette shown in FIG. 10 maintain a fixed gap so when cutting knife 2035 (a flexible plate) is introduced the blank is cut consistently and knives are not damaged.

The setup time for a score & cut is significantly reduced.

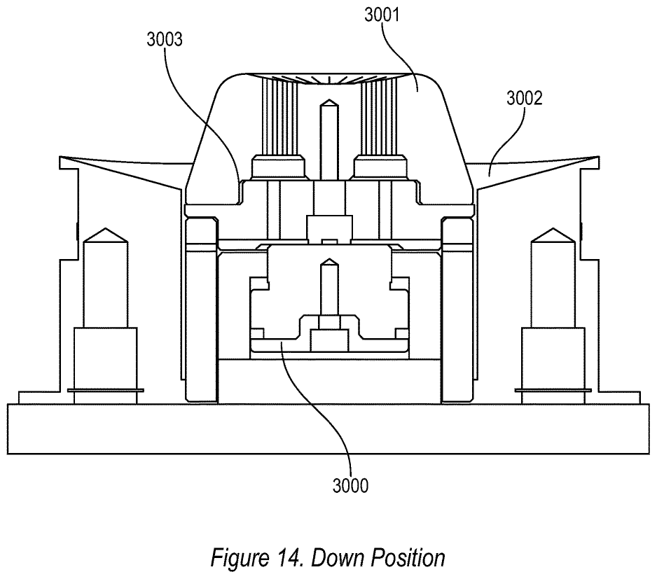

Hydraulic male form is shown in FIG. 13 (UP POSITION) and in FIG. 14 in the DOWN POSITION.

The hydraulic cylinder 3000 under the male form 3001 extends the male form 3 mm above the die bottoming out which allows the male form to nest completely in the female form giving a consistent shape to the container. The cylinder is then depressurised at the bottom of the stroke allowing all the press force to be exerted onto the flange 3002 as will be appreciated from FIG. 14. This concept will yield both a better shaped container as shown in FIG. 15C and a flatter flange 3002 which makes downstream operations at our customer more consistent.

### Advantages

The preferred embodiment provides significant advantages over traditional manufacturing processes, including:
Deskilling the die-setting setup process
Easier, faster die/score and cut setup
Longer working life for the scoring and cutting process
Longer working life (less operating cost) for the cutting knives
Better quality and more consistent container
More consistent product, which in turn will give our customers a better production outcome
With the male forms we have made the bolts which fix the form in male place more easily assessable for maintenance staff to realignment after a jam up.

In both functions the level of expertise required by the person setting the machine is dramatically reduces as each function is performed separately.

With the Rotary Score & cut a consistent score depth is maintained from run to run without the need of a fiddly set up. The cutting is maintained, and knife life is extended as the operator cannot over stroke the knives as the height is maintained with “bearers” on the support rollers

The Hydraulic male form ensures good shape of the container is maintained without significant input from the person setting the die It will maintain good shape throughout the manufacturing process and not be pushed out of alignment should there be a jam up in the press. Turning off the pressure on the hydraulic male form at the bottom of the stroke allows the full force of the press to act on the flange of the container resulting in a flatter flange which is desired for both stability of the tray & a better surface on which to seal a lid.

### Variations

In the preferred arrangement the sequence of operations in order are:
1. Scoring
2. Cutting
3. Shaping.

The order could, theoretically, be changed but you would lose control of the web, making alignment much more difficult. Shaping should preferably come last as the forming blanks are created by the score and cut units.

We prefer to use rollers for the score and cut steps as this gives greater control. However, it is possible to use individual flatbed presses for the score and cut. An issue with this is the force involved to score and cut every edge at once is quite high. You would also reintroduce the issue with uneven cutting/scoring across the profiles if the tooling/press is not perfectly flat and aligned.

The invention can be used with plain board or plastics coated board.

A film could also be applied to the pressed board and flange after manufacture.

The machine can be built in right or left-handed configurations depending upon the customer's requirements and ease of access to the controls. In the description and drawings we have described a right-hand configuration of the machine.

1. A method of manufacturing pressed board trays in which a continuous web of paperboard or fibreboard is passed through separate pair of scoring rollers before being passed to a separate pair of cutting rollers to create shaping blanks which are then fed to a separate forming press.

2. The method as in claim 1 where the web is passed through a Decurl cassette before entering the scoring rollers.

3. A machine for manufacturing pressed board trays having a source of a continuous web of paperboard or fibreboard and means for feeding the web into the machine having a scoring cassette separated from a cutting cassette, and a separate forming press.

4. The machine as claimed in claim 3 wherein the machine also includes a Decurl cassette between the source of the web and the scoring cassette so that the web can be flattened/uncurled before entering the scoring cassette.

5. The machine as claimed in claim 3 wherein the scoring cassette has a pair of rollers to score the web.

6. The machine as claimed in claim 3 wherein the cutting cassette has a pair of rollers to cut the web.

7. The machine as claimed in claim 3 wherein the cutting cassette has a magnetic cylinder and an anvil cylinder, the magnetic cylinder supporting a magnetic knife so that the cutting pattern can be easily changed by removing the magnetic knife and inserting a different magnetic knife.

8. The machine as claimed in claim 3 wherein the source of the web is provided by an unwinder having a roll drive wheel capable of supporting a roll of paperboard or fibreboard and a guided pneumatic cylinder to raise and lower the roll drive wheel.

9. The machine as claimed in claim 8 wherein the roll drive wheel is driven by an electrical gearmotor acting on a large cast aluminium wheel bung.

10. The machine as claimed in claim 8 wherein there is a sensor which generates a signal to automatically control the amount of web being unwound in use.

11. The machine as claimed in claim 3 wherein the scoring cassette has a pair of rollers to score the web.

12. The machine as claimed in claim 3 wherein the cutting cassette has a pair of rollers to cut the web.

13. The machine as claimed in claim 3 wherein the cutting cassette has a magnetic cylinder and an anvil cylinder, the magnetic cylinder supporting a magnetic knife so that the cutting pattern can be easily changed by removing the magnetic knife and inserting a different magnetic knife.

14. The machine as claimed in claim 3 wherein the forming press has a male form which can be moved hydraulically towards and away from the female form to allow the blank to be formed separately from pressing a flange around the tray.

15. A machine for manufacturing pressed board trays having a source of a continuous web of paperboard or fibreboard comprising a roll drive wheel capable of supporting a roll of paperboard or fibreboard and a guided pneumatic cylinder to raise and lower the roll drive wheel capable of feeding the paperboard or fireboard towards processing stations.

16. The machine as claimed in claim 15 wherein the roll drive wheel is driven by an electrical gearmotor acting on a large cast aluminium wheel bung.

17. The machine as claimed in claim 15,
wherein there is a sensor which generates a signal to automatically control the amount of web being unwound when in use.

The machine as claimed in claim 15 wherein the machine also includes a Decurl cassette between the source of the web and the processing stations so that the web can be flattened/uncurled before being processed.
